(19) United States
(12) Patent Application Publication
(10) Pub. No.: US 2021/0295248 A1
(43) Pub. Date: Sep. 23, 2021

(54) SYSTEM AND METHOD FOR INVENTORY MANAGEMENT

(71) Applicant: Venture Measurement Company, LLC, Spartanburg, SC (US)

(72) Inventors: Brian T. JAMIESON, Simpsonville, SC (US); Christopher J. HAMPTON, Taylors, SC (US); Tusharkumar P. PATEL, Greer, SC (US); Antonio LOPEZ, Lexington, SC (US)

(73) Assignee: Venture Measurement Company, LLC, Spartanburg, SC (US)

(21) Appl. No.: 17/250,442

(22) PCT Filed: Jul. 25, 2019
(86) PCT No.: PCT/US19/43476

§ 371 Date: Jan. 21, 2021

Related U.S. Application Data
(60) Provisional application No. 62/703,288, filed on Jul. 25, 2018.

(51) Int. Cl. G06Q 10/08; G01G 19/414; G01G 23/36; G01G 23/48

(52) U.S. Cl. CPC G06Q 10/087; G01G 23/48; G01G 23/36; G01G 19/414

(57) ABSTRACT

A system including a smart junction box (SJB) device having an adjusted weight measurement calculator (AWMC) module. The AWMC module configured to calculate an adjusted weight measurement representative of a weight of the stored material in bin based on the sensed weight measurement from those weight measurement sensors in a non-failure state and an ambient environmental condition compensation factor (AECCF), during the weight measurement cycle. The SJB device includes a thermometer to measure a local ambient temperature for use in determining the AECCF. The SJB device is configured to calculate the adjusted weight measurement based on the signals from the remaining sensors in a non-failure state while ghosting the failed sensor.

### FIELD

The present invention relates generally to inventory management and, more particularly, to a system and method for quantitively measuring the amount materials stored in a vessel.

### BACKGROUND

Today it can be important for a company to know and understand its inventory. Understanding inventory down to the last unit can provide for much greater efficiency in operations and inventory management. Such efficiency can bring cost savings and a more productive work flow. Bulk inventory can sometimes be difficult to measure due to its size and difficult vessel or bins conditions. To alleviate such difficulties, weight sensors may be used for determining the amount of material in inventory.

A particular problem with known weight sensor systems, however, is that a sensor may need to be placed on each leg of a vessel, or other appropriate location that exhibits stress due to a weight of the material in the vessel, in order to provide a suitably accurate measurement. Unfortunately, when multiple weight sensors are needed for accurate measurement, the failure of a single weight sensor can cause the entire system to provide inaccurate measurements or to fail all together.

### SUMMARY

In order to provide an improved inventory management system and to overcome the disadvantages and problems of currently available systems, there is provided an improved system, method and device that tracks inventory based on measured weight or level of materials held in a vessel. Aspects of such a system may further relate to systems that may use temperature compensated inventory measurements based on a local ambient temperature. The system may also relate to a graphical user interface to display information related to inventory tracking based on weight or level of the inventory material.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1A illustrates a block diagram of an inventory management system for a location interfaced with one or more material suppliers, one or more material transportation systems and optional local weather center;

FIG. 1B illustrates a diagram an inventory management system for a location with inventory (material) level sensors;

FIG. 2 illustrates a block diagram of the inventory management system with the bins, legs and material removed for a plurality of locations;

FIG. 3A illustrates a block diagram of a smart junction box (SJB) device of the inventory management system interfaced with a set of weight sensors and cloud;

FIG. 3B illustrates a housing of the SJB device of FIG. 3A;

FIG. 4 illustrates a block diagram of a cloud with an adaptive ambient environmental condition compensation factor (AECCF) analytics module associated with the remote inventory monitoring and management;

FIG. 5A illustrates a flowchart of a method for calculating a weight of material within a bin being adjusted by an ambient temperature condition compensation factor (AECCF);

FIG. 5B illustrates a table for use in determining an ambient environmental condition compensation factor (AECCF);

FIG. 6A illustrates a graphical user interface (GUI) for adding a location to be monitored and managed;

FIG. 6B illustrates a graphical user interface (GUI) for editing a location by selecting users with permitted access;

FIG. 6C illustrates the GUI with a plurality of individually selectable bins previously added, e.g., all bins associated with a particular location;

FIG. 6D illustrates the GUI of FIG. 6C for adding bins with a pop-up box for entering the bin tracking information of a single bin;

FIG. 7A illustrates a graphical user interface (GUI) having a plurality of bin icons representing percent of material within a plurality of bins with a notification window of notification for the plurality of bins at a plurality of locations;

FIG. 7B illustrates a window with a graphical representation including a bar graph of the predicted time to empty (depletion) of the one or more bins;

FIG. 7C illustrates a window with a graphical representation including a bar graph of the consumption rate of the material in each respective bin monitored;

FIG. 8A illustrates a graphical user interface (GUI) with a notification window overlaid on the GUI of FIG. 7A;

FIG. 8B illustrates a notification window for use in FIG. 8A;

FIG. 9 illustrates the GUI to adjust the graphical representations of FIGS. 7A-7C;

FIG. 10A illustrates a graphical user interface (GUI) for inventory tracking and scheduling of a single selected bin denoted in selected box within window displaying an array of bins for at least one location;

FIG. 10B illustrates a further graphical representation depicting inventory history for a predetermined amount of time for a selected bin;

FIG. 11 illustrates a graphical user interface to modify the data represented by the inventory graphical representation, the time to empty graphical representation, consumption rate graphical representation and the inventory scheduling graphical representation; and

FIG. 12 illustrates a block diagram of a computer system.

### DETAILED DESCRIPTION OF THE PRESENT EMBODIMENTS

Embodiments are described herein with reference to the attached figures wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10 (e.g., 1 to 4).

With weight-based measurement, the disadvantages of existing inventory management systems can be reduced or eliminated. Weight-based measurement can provide a reliable and consistent indication of an amount of material in a vessel, or other suitable container, regardless of the material's movement or distribution within the vessel. In addition, with weight-based measurement there is no need for human contact with the material or compromising the vessels integrity; non-intrusive. Another advantage of weight-based measurement is that bulk density and other material characteristics do not impact the measurements. Similarly, bin conditions, like voids, cascading material, or bridging, do not affect the measurement of the material.

One method of implementing a weight-based measurement system is by applying one or more weight sensors to the vessel from which a weight measurement is desired. A weight sensor may include a bolt-on strain gauge sensor, such as, for example, a Microcell® sensor from Kistler-Morse of Spartanburg, S.C. Such strain gauge sensors measure the strain on a leg of a vessel (e.g., a feed bin). One benefit of these weight sensors is that they are not intrusive to the vessel. They can simply be bolted onto each leg of the vessel and output a value based on the strain forces imposed on the respective leg by the weight of the material in the bin. That value representative of the strain forces can then be correlated with a numerical value representative of a weight that is associated with that strain force value.

Alternative weight sensors, such as load cells from Kistler-Morse of Spartanburg, S.C., can require placement under each leg of the vessel, which may require the vessel to be lifted in cases where the vessel is already erected. Additionally, it will be appreciated that replacing a failed load cell can be a similarly difficult task. Still other weight sensors can require the leg to be cut and a sensor installed with a cell in tension. As such, installation and use of some of these weight sensors may be beyond the skill set of a typical user. A bolt-on strain gauge sensor such as the aforementioned Microcell®, however, merely needs two holes drilled and tapped into the leg, which can be utilized to mount the bolt-on strain gauge.

Other weight sensors that directly produce a numerical weight value may be used. For the purpose of disclosure, the electrical output from any one weight sensor may be referred to as a weight signal.

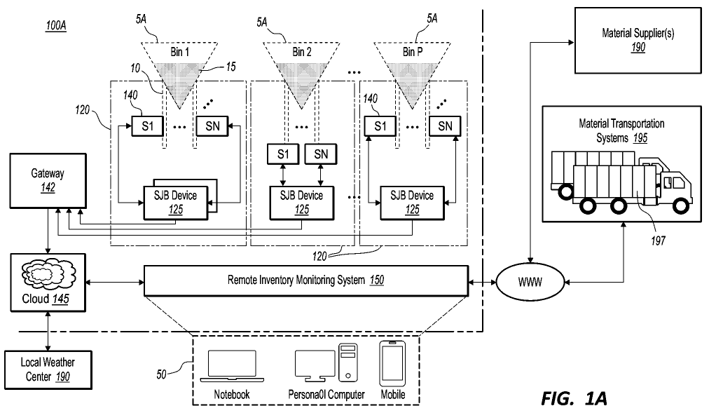

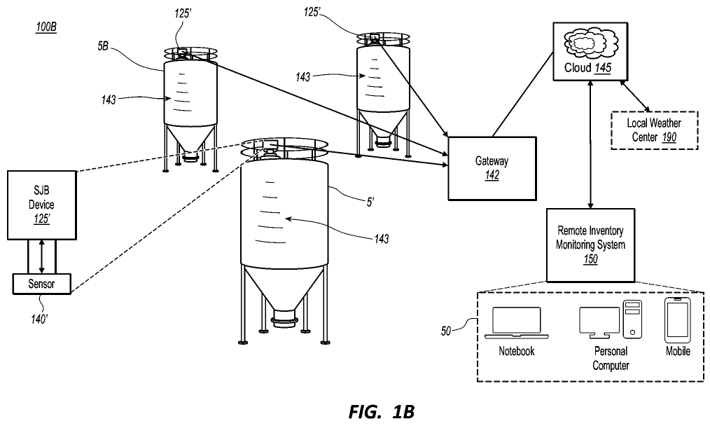

FIG. 1A illustrates a block diagram of an inventory management system 100A for a location interfaced with one or more material suppliers 190 and one or more material transportation systems 195. The vessels 5A are denoted in dashed lines to indicate that they are not part of the inventory management system 100A. Each vessel 5A includes a bin. The bins of the vessels 5A are labeled bin 1, bin 2, . . . , bin P and include a quantity of material 15 to be measured. The number P is a non-zero integer. The vessels 5A may include legs 10 to support the bins both of which are represented as dashed lines to indicate that they are not part of the inventory management system 100A. In some embodiments, the bins and legs may be part of the inventory management system 100A.

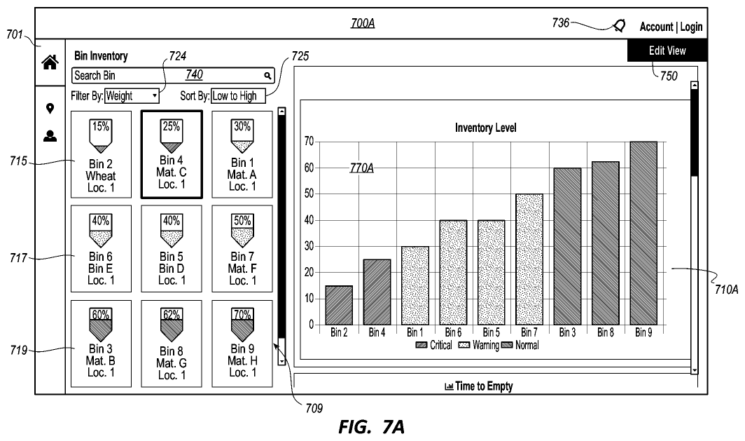

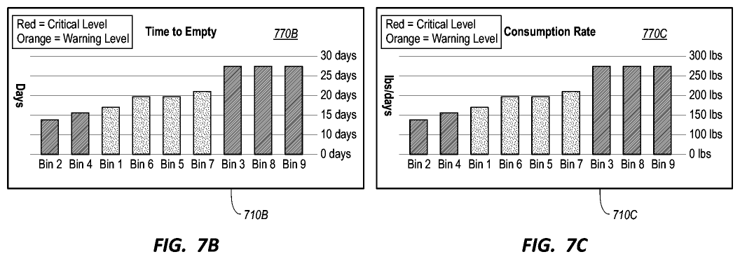

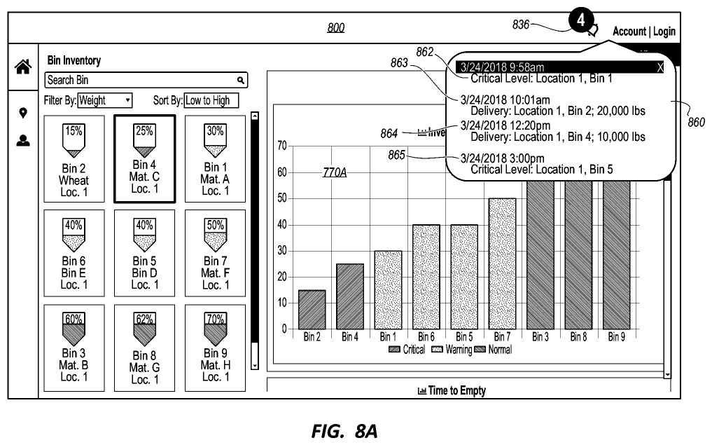

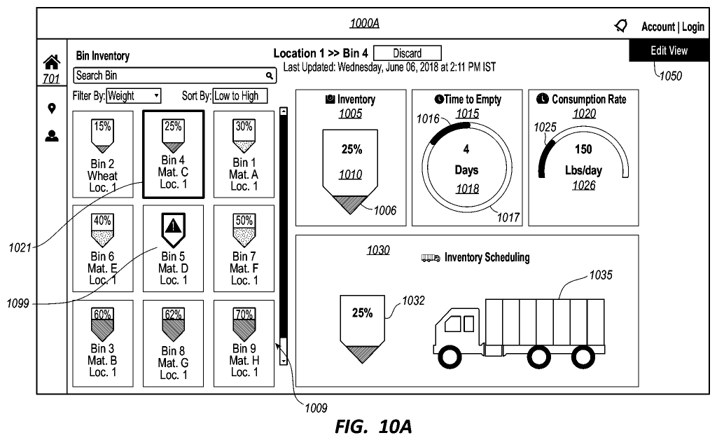

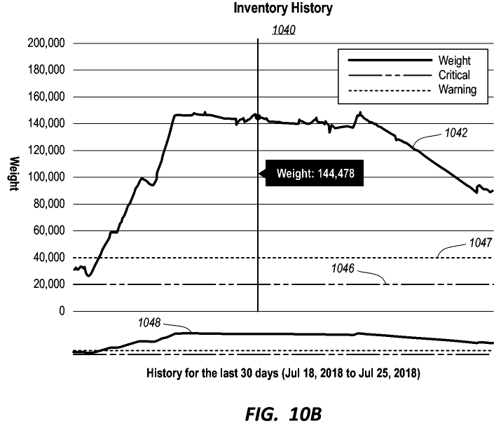

The inventory management system 100A may comprise a remote inventory monitoring system 150 including instruction stored in a tangible, non-transitory computer readable medium of computing device 50. The computing device may include a Notebook, Personal Computer (PC), and/or mobile device. The instructions of the remote inventory monitoring system 150 is configured to interface with one or more computing device platforms, such as without limitation, Notebook, Laptop, PC and mobile device. The remote inventory monitoring system 150 may be configured to monitor material weight, material levels and/or track real-time inventory quantity parameter of one or more bins (FIGS. 7A and 10B), track time to deplete (empty) the material supply in one or more bins (FIGS. 7B and 10A), consumption rate tracking (FIGS. 7C and 10A), and perform inventory scheduling (FIG. 10A), by way of example. In some embodiments, the inventory scheduling (FIG. 10A) may be a function of available capacity in a material transportation vehicle 197. The inventory scheduling may require ordering an amount of material for transportation by the available material transportation vehicles 197 of the one or more material transportation systems 195. The vehicle 197 is represented as a truck. In some instances, the transport vehicle 197 may include a combination of one or more of truck, train, cargo airplane and ship.

The remote monitoring system 150 may communication with cloud 145 via wired or wireless communications. By way of non-limiting example, the wired communications may include optical fiber and/or cable communications for connection to the World Wide Web, Internet or Intranet.

The inventory management system 100A comprises one or more inventory measurement systems 120, represented within a dash dot dash box. Each remote measuring system 120 comprises a set of individually addressable inventory measurement sensors 140 associated with a set of legs and each inventory measurement sensor 140 may detect, in some embodiments, an electrical output representative of a weight signal of a weight of the vessel and material and/or the associated leg relative to a material weight in a bin of the vessel to produce an inventory measurement signal in response to excitation. The terms “inventory measurement sensor,” “weight sensor” and “level sensor” (FIG. 1B) may be used interchangeably herein.

The plurality of inventory measurement systems 120 may send measurement signals for storage in a cloud 145 via a gateway 142. The remote inventory monitoring system 150 may access the cloud to retrieve the inventory quantity parameter whether it is a remaining material weight or a remaining material level for selectively displaying an updated inventory quantity of for a location or bin. Each inventory measurement system 120 may communicate, wired or wirelessly, via the SJB device 125 to the gateway 142. In some embodiments, the wireless communication protocol may include a Bluetooth® protocol, LoRa® technology or other wireless protocol. LoRa® (long range) technology includes wireless communications which may support wide area networks (WAN) and local area networks (LAN). The gateway 142 may communicate with the cloud 145 via wired or wireless communication protocols. By way of non-limiting example, the wireless communication protocol may include cellular communications such as to a public cellular network. The wired communications may include optical fiber and/or cable communications for connection to the World Wide Web, Internet or Intranet. In some embodiments, communications between the SJB device 125 and the gateway 142 may include Wi-Fi communications protocol.

The inventory measurement system 120 of FIG. 1A will now be described in detailed. The inventory measurement system 120 may comprise N number of inventory measurement sensors denoted as S1, . . . , SN coupled to one or more legs supporting a bin of a vessel. Each inventory measurement sensor senses a parameter associated with a leg or other part of a vessel 5A to which it is attached to determine an inventory measurement signal representative of a weight of the vessel 5A including a quantity of stored material stored within the vessel's bin. The N number is a non-zero integer. In some embodiments, each bin may require more than one inventory measurement systems 120.

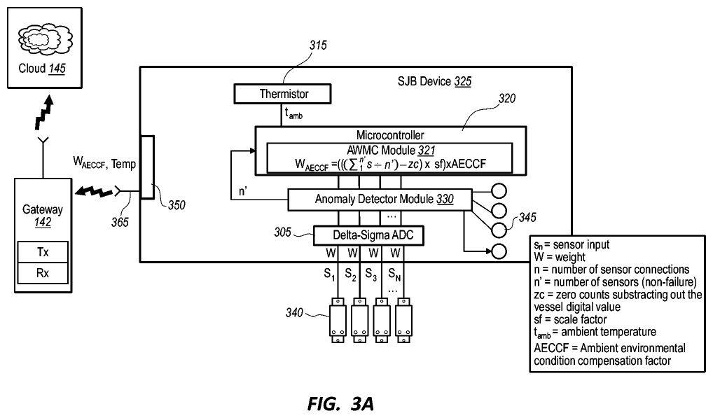

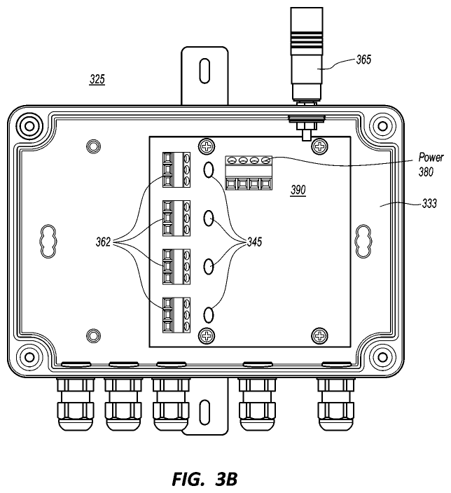

By way of non-limiting example, each leg or other part of a vessel may have at least one measurement sensor 140. In some embodiment, a leg may have one sensor coupled thereto such as a load cell type sensor or strain gauge. The more measurement sensors 140 attached to the vessel 5A whether it is on the legs or other parts, the accuracy of the inventory measurements may improve. The number of SJB devices 125 used in an inventory measurement system 120, may be a function of the number of connector ports available in the SJB device 125. For illustrative purposes, the SJB device 125 may have four connector ports, as will be described in relation to FIG. 3B.

The embodiments herein provide an SJB device 125 having coupled thereto a set of individually addressable inventory measurement sensors 140, also labeled individually as S1, . . . , SN wherein the number N is a non-zero integer. The SJB device 125 may be configured to determine when an inventory measurement sensor 140 has failed. By way of non-limiting example, the SJB device 125 may detect a measurement anomaly from a received signal of a sensor.

In operation, the SJB device 125 may communicate an adjusted inventory measurement for each inventory measurement cycle. The adjusted inventory measurement may be a function of a single sensor reading (highest, lowest, or middle), an average of one or more sensor readings (e.g., an average of the measurements provided by the remaining inventory measurement sensors), or any other suitable derivation from the remaining measurements. The SJB device 125 determines the adjusted inventory measurement without the need for reading of the failed weight sensor. As such, an inventory measurement system 120 can still provide accurate readings after failure of one or more of the inventory measurement sensors. Consequently, a user does not need to take immediate action as the result of a failure.

FIG. 1B illustrates a diagram an inventory management system for a location with inventory (material) level measurement sensors 140′. In some embodiments, the inventory of material in a particular bin 5B may be tracked by continuous inventory (material) level sensors 140′. The level measurement sensors 140′ may include other sensors configured to sense an amount of material remaining or weight of material remaining within a bin of a vessel. For example, light detection and ranging (LIDAR) sensors, cameras, radar, laser range finders, ultrasound or the like may be used to detect a remaining level of material by detecting the depth level of the inventory (material) within the bin 5B. The measurement signal from the level measurement sensor 140′ is sometimes referred to as an inventory (level) measurement of a quantity of inventory or material.

Thus, the sensed weight of the material within a bin 5B and the sensed level of the inventory or material, within a bin 5B, are sometimes herein referred to as an inventory quantity parameter wherein the sensed weight of material or the sensed level of material serve to derive a tracked inventory quantity parameter representative of the inventory of the remaining amount in pounds or percentage within a bin. After a fill process the inventory of material is replenished. The inventory quantity parameter is representative of the replenished inventory of material.

The material level measurement sensors 140′ are mounted to a location of the bin above the maximum material level established for the bin 5B. The material level measurement sensor 140′ sends a ranging signal within the bin 5B. The ranging signal is interpreted and converted to a percentage representative of a level of the material within the bin 5B, for example.

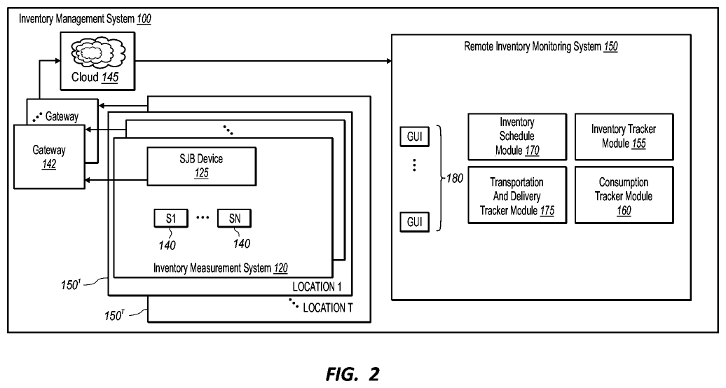

FIG. 2 illustrates a block diagram of the inventory management system with the bins, legs and material removed for a plurality of locations labeled LOCATION 1, . . . , LOCATION T wherein T is a non-zero number. In some embodiments, an inventory measurement system 120 at any one or more locations may include at least one of weight measurement sensor 140 and level measurement sensor 140′.

As best seen in FIG. 2, the remote inventory monitoring system 150 may comprises an inventory tracker module 155 configured to track individually and collectively a content within a plurality bins, receive from the plurality of inventory measurement systems 120 the inventory measurement data for each respective measurement cycle. The inventory measurement data may be adjusted based on temperature compensation. The inventory tracker module 155 may be configured to update and track a quantity of the stored material in each bin corresponding to the adjusted inventory measurement data for one or more bins received from at least one SJB device 125 for an inventory measurement cycle. After each cycle, updated inventory levels may be displayed on a display screen via one or more graphical user interfaces (GUIs) 180, as will be described in more detail in relation to FIGS. 7A-7C and 10A-10B. The updated inventory level may correspond to the actual measured weight (i.e., pounds, tons) of the material in a bin during the cycle. In other embodiments, the updated inventory level may correspond to a level of measured material within the bin. In some embodiments, the updated inventory level relative to the capacity of the bin may be determined based on the remaining percentage of material relative to the capacity of or starting quantity of material in the bin.

The remote inventory monitoring system 150 may comprises a consumption tracker module 160. The consumption tracker module 160 is configured to determine, after at least one inventory measurement cycle, an amount depleted since the last cycle. The consumption tracker module 160 may track an amount of consumption for a period of time, such as without limitation, a daily rate of consumption or consumption over 24 hours. The rate of consumption may be displayed in a GUI, such as shown in FIGS. 7C and 10A.

In other operations, the consumption tracker module 160 may track consumption for other periods of time such as without limitation, hourly rate of consumption and weekly rate of consumption. The period of measurement to determine the consumption rate is not limited to the listed periods. The consumption tracker module 160 may be configured to update a consumption rate as determined by the difference in the received weight or level from an SJB device 125 for a particular increment of time (i.e., hourly, weekly, or monthly).

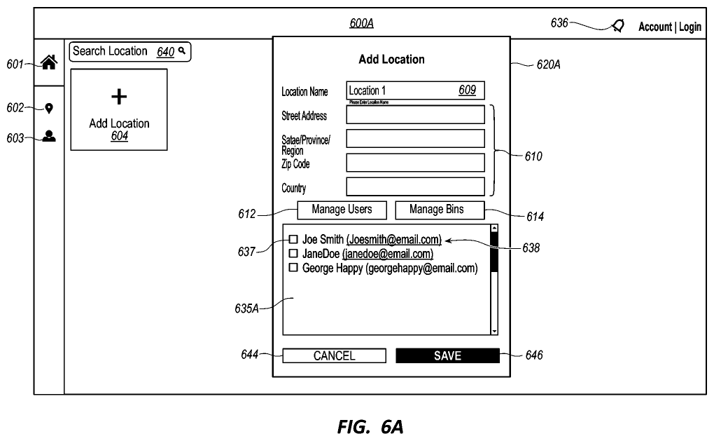

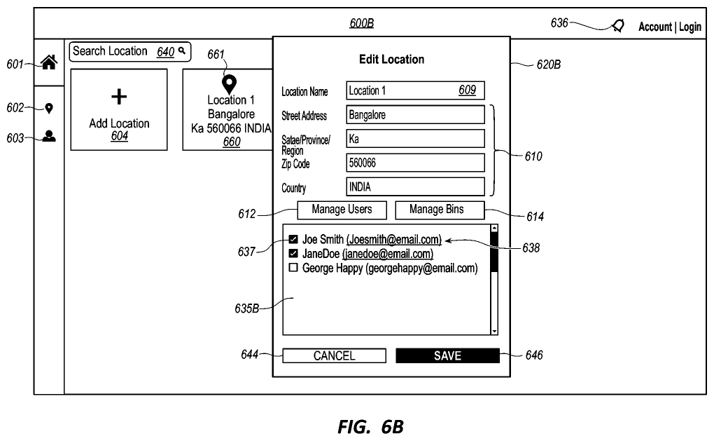

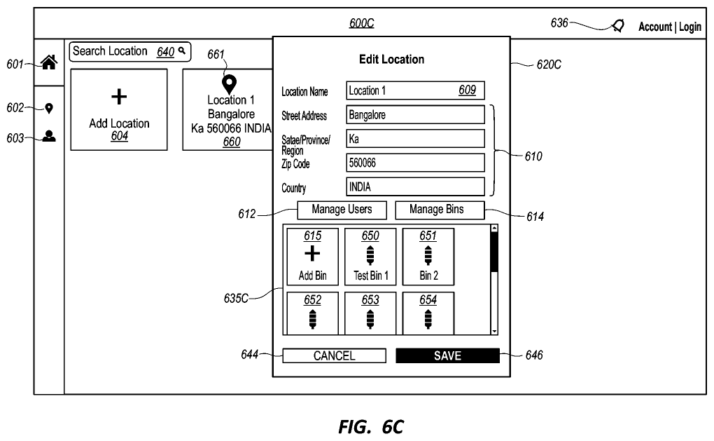

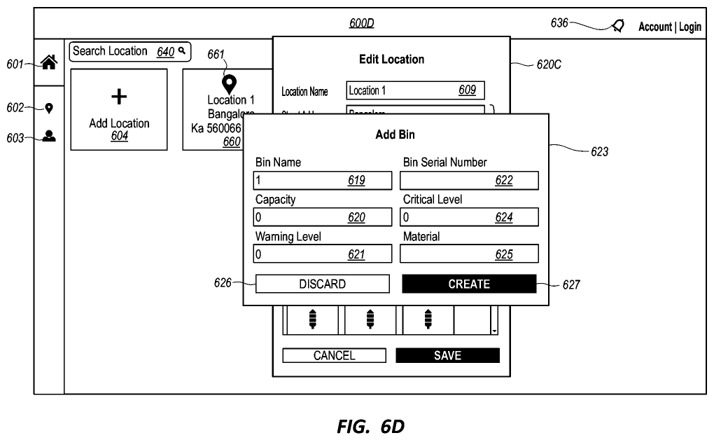

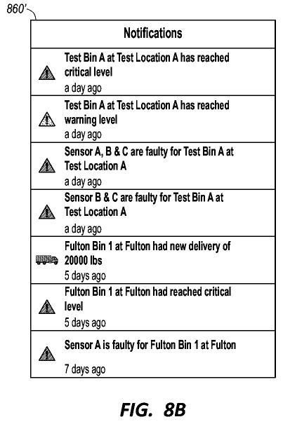

The remote inventory monitoring system 150 may include an inventory scheduler module 170. The system 150 may set certain trigger points of an amount of remaining material, as shown in FIG. 6D, to trigger a notification message, as shown in FIG. 8A or 8B. The critical-level trigger point may be set to require an operator to order or schedule material immediately to replenish the bin's material to the highest set point representing 100% or near 100%, as will be described in relation to FIG. 10A. The highest set point may vary per bin.

The critical-level trigger point may vary based on the consumption rate and an expected time of arrival for an ordered amount of material to be delivered. For example, the expected time of arrival may include the time to travel the distance between the material supplier 190 to the location of the bin and speed limits along the trip path. The expected time of arrival may also be a function of time to fill the ordered material by a supplier 190. Once, the critical-level trigger point is reached, the color of a bin icon may change colors, as described below in relation to FIGS. 7A-7C and 10A-10B. The term color may be substituted with a pattern to visually distinguish between the quantity levels of material. In some embodiments, a color and pattern may be used to visually distinguish between quantity levels.

The remote inventory monitoring system 150 may further include a transportation and delivery tracker module 175 configured to track one or more vehicles' capacity for pickup and delivery of a quantity of material to replenish the bin to 100% capacity, as shown in FIGS. 10A. Furthermore, the transportation and delivery tracker module 175 may determine an amount of material filled within a vehicle's compartment so that the right amount of material is ordered and the number of vehicles 197 are used to replenish the depleted supply of material in one or more bins. For example, if a bin needs a replenishment quantity of 70% of the storage capacity in bin but the vehicle 197 has extra storage capacity, the remaining truck compacity may be used to transport an amount of the material or a different material for another bin at the same location or a different location, if segregated sections are available in the vehicle. For example, if a vehicle has is filled with a first material to 75% of its capacity for a first bin, the remaining 25% may be used for storing material to replenish another bin in part or whole, as will be described in more detail in relation to FIG. 10A.

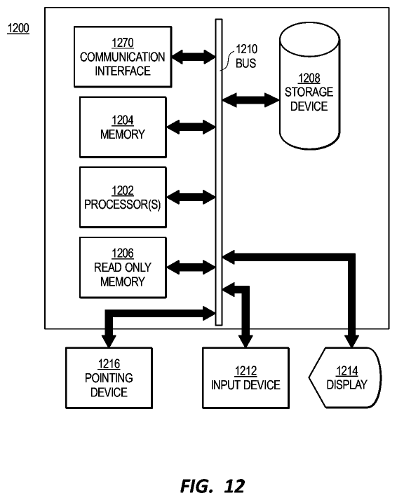

The remote inventory monitoring system 150 may be executed on a computing device 50 or computing system, as will be described in relation to FIG. 12, having one or more processors which when executing the instructions perform the functions of the inventory tracker module 155, consumption tracker module 160, inventory scheduler module 170, transportation and delivery tracker module 175. These modules 155, 160, 170, and 175 may represent programming code (instructions) for carryout the functions described herein and/or computing resources for executing the programming code.

FIG. 3A illustrates a block diagram of a smart junction box (SJB) device 325 of the inventory management system 100A interfaced with a set of inventory measurement sensors 140 (FIG. 1A) and a cloud 145 via gateway 142. For the purposes of illustration, the inventory measurement sensors 140 (FIG. 1A) are individually addressable weight sensors 340. There are N weights sensors 340 wherein N is 4. The number N may be a non-zero integer. The SJB device 325 may excite each individually addressable weight sensor S1, S2, S3, . . . , SN. The SJB device 325 may be configured to excite the individually addressable measurement sensors 340. The received inventory (weight) measurement signals are converted from analog to digital in an analog-to-digital converter (ADC) 305. The SJB device 325 may comprise one or more processors or microcontrollers 320 and may function as a computing system, as will be described in more detail in relation to FIG. 12. The SJB device 325 via communication port 350 may communicate with gateway 142, either wired or wirelessly. For illustrative purposes, the communication port 350 is coupled to antenna 365 for wireless communication. The communication port 350 may include a transmitter for transmitting the inventory measurement to the cloud 145 via the gateway 142. The antenna 365 may be compatible for transmitting LoRa® communications. The gateway 142 may include at least one antenna. For example, the gateway 142 may include an antenna to receive wireless communications from SJB device 325. The gateway 142 may include a second antenna for transmitting wireless communications to the cloud 145. In wired communications between the SJB device 325 and/or the cloud 145, one or more of the antenna associated with the gateway 142 may be optional. The gateway 142 is shown with at least one transmitter Tx and at least one receiver Rx.

The microcontroller 320 includes an adjusted weight measurement calculator (AWMC) module 321 configured to calculate the adjusted inventory (weight) measurement. An example formula is shown within module 321.

The SJB device 325 may further comprise an anomaly detector module 330 may be coupled to the output of the ADC 305. In some embodiments, the anomaly detector module 330 may be coupled before the input to the ADC 305. The anomaly detector module 330 may be configured to detect an anomaly of each individually addressable weight sensor S1, S2, S3, . . . , SN in response to the received electrical output signal representative of the inventory (weight) measurement signal of each individual sensor to determine whether any one addressable weight sensor is in a failure state.

The inventory (weight) measurement signals are evaluated by the anomaly detector module 330 to detect failed sensors in the set of inventory (weight) measurement sensors 340 and generate an indicator signal representative of a state of the sensor via indicators 345. If an inventory (weight) measurement sensor is failed, the indicator 345 associated with the failed sensor may generate a red light. If the sensor is in a non-failure state, the indicator 345 associated with the non-failed sensor may generate a green light. Nonetheless, other indicators and colors may be used.

The anomaly detector module 330 may include determining whether a weight sensor is open circuited, short circuited, or through another failure indicator (e.g., above a threshold difference in measurement from the other weight sensors, rapid fluctuations of measurements). It will be appreciated that the mechanism for determining the failure of a measurement sensor 340 should not be treated as limiting of this disclosure. Any mechanism for determining that a weight sensor has electrically failed is contemplated herein. The threshold difference in measurements of the set of sensors coupled to a particular vessel 5A (FIG. 1A), may be a function of sensor tolerances. For example, the inventory (weight) measurement sensors may have a tolerance of ±1%, by way of non-limiting example.

A detected anomaly by the anomaly detector module 330 of each individually addressable inventory (weight) measurement sensor 340 may comprise one of an open circuit condition, a short circuit condition, measured signal out-of-expected range, rapid measured signal fluctuations and a non-responsive condition.

The SJB device 325 may comprise a communication port 350 configured to communicate wired or wirelessly to the remote inventory monitoring system 150 (FIG. 1A) and to cause the remote inventory monitoring system 150 to update a quantity of the stored material corresponding to the received adjusted inventory (weight) measurement (W_{AECCF}) associated with a current inventory measurement cycle. The SJB device 325 may communicate to the cloud 145 via the gateway 142 the temperature associated with the current measurement cycle. In some embodiments, the SJB device 325 may communicate to the cloud via the gateway 142 a time stamp with date and time. In some embodiments, the SBM device 325 may also communicate to the cloud 145 via the gateway the status of any inventory (weight) measurement sensors 340.

Once the SJB device 325 has determined one or more of the inventory (weight) measurement sensors 340 have failed, the SJB device 325 can provide an output to a user/operator of the SJB device 325, as will be described in relation to FIG. 3B, and/or the remote inventory monitoring system 150 (FIG. 1A) that the one or more sensors 340 have failed via the communication port 350.

In some configurations, an indicator 345 being indicative of a status (i.e., failed state or non-failure state) of an inventory measurement sensor 140 may also be provided to the user such as in proximity to connectors associated with each individual weight measurement sensor. In some instances, the SJB device 325 may be configured to then provide an estimate of the material contained within the vessel based on outputs of any remaining inventory (weight) measurement sensors 340 that are still properly functioning or in a non-failure state. Thus, as long as one inventory (weight) measurement sensor, coupled to the vessel and the SJB device 325, is operational, the SJB device 325 is configured to continue providing inventory (weight) measurements to the remote inventory monitoring system 150 (FIG. 1A).

The example herein is for illustrative purposes. In the example, a vessel 5A (FIG. 1A) may have four legs. The SJB device 325 may have four inventory (weight) measurement sensors 340, each sensor associated with a leg or other part of the vessel. If one inventory (weight) measurement sensor fails, the readings from one or more of the other inventory (weight) measurement sensors 340 can be utilized to determine an adjusted inventory (weight) measurement without the failed (weight) measurement sensor. In other words, the adjusted inventory (weight) measurement may be derived from all of the remaining (weight) measurement sensors 340 in the non-failure state.

If a (weight) measurement sensor 340 is determined to be in a failure state, the SJB device 325 may ghost the one or more failed inventory (weight) measurement sensors, if present. Each failed (weight) measurement sensor is reported as failed to an operator for repair or replacement, if necessary. The failed sensor indicator signal may also be sent to the remote inventory monitoring system 150. However, the weight or inventory quantity can still be determined by removing (ghosting) the failed (weight) measurement sensor's reading from any further calculations in a current inventory measurement cycle. Any subsequent measurement cycle, the SJB device 325 may reevaluate a previously-failed (weight) measurement sensor to determine if a previously-failed (weight) measurement sensor has been repaired, replaced, or operational in working limits.

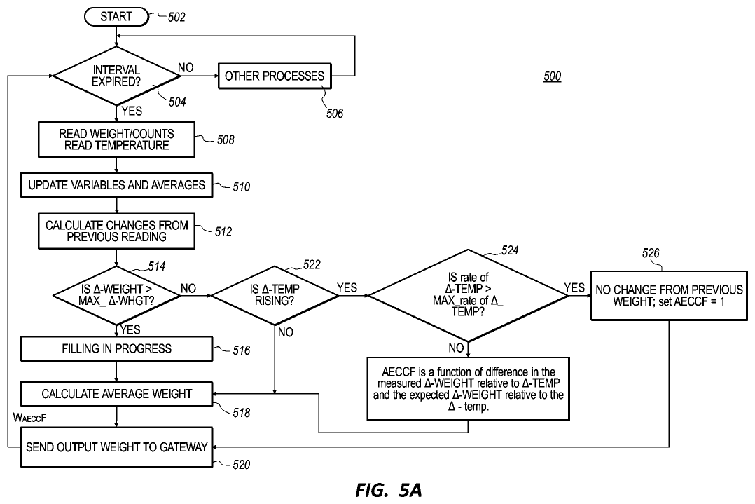

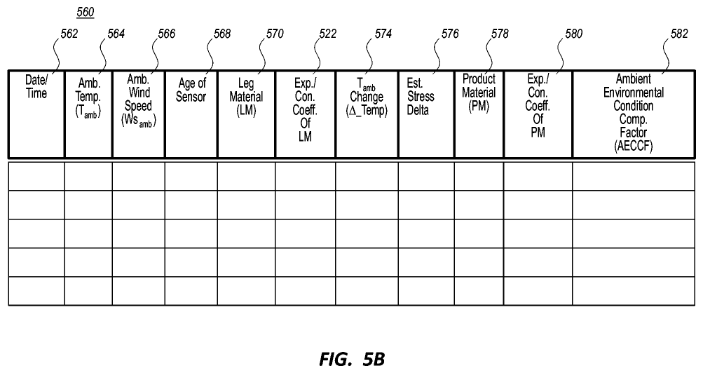

The SJB device includes a temperature sensor device to measure a local ambient temperature for use in determining the AECCF, as will be described in relation to FIG. 5A. The SJB device 325 is configured to calculate the adjusted inventory (weight) measurement based on the signals from the remaining inventory (weight) measurement sensors in a non-failure state while ghosting the failed sensor(s).

Weight sensors (Microcell® Bolt-On Sensor) (i.e., measurement sensor 340) may be placed on a vessel's stainless steel support legs supporting a storage bin. Each vessel may weigh 4-5 tons with full capacity of material. The SJB device 325 sends data (measured weight and temperature) to the cloud 145, for example, at minute level frequency (inventory measurement cycle) to be utilized to calculate the AECCF, as described in relation to FIG. 5A. Due to the day-night temperature variations, location temperatures and/or seasonal temperature variations, the steel legs or vessel could expand or contract which may cause an error in a weight measurement output from the SJB device 325. The temperature effect on support legs and/or vessel varies between vessel, as they may not be manufactured by same vendor or they could even be different material all together. Therefore, a constant offset calibration factor has been found to be less accurate. Thus, in some embodiments, an ambient environmental condition compensation factor (AECCF) may be derived based on the ambient temperature T_{amb} measured during an inventory measurement cycle and the amount of stress measured or other electrical output from an inventory measurement sensor 340 representative of a collective weight of the vessel and material and/or leg(s) to which the weight sensor is mounted.

The term “adjusted weight measurement” is a weight of essentially only the material 15 (FIG. 1A) within the bin of a vessel 5A (FIG. 1A) which may be adjusted for ambient environmental conditions. The adjusted weight measurement may be communicated to the cloud 145 for storage in a database. The term “adjusted weight measurement” and “adjusted inventory (weight) measurement” may be used interchangeably herein.

The SJB device 325 (FIG. 3A) may comprise a temperature sensor device with a thermistor 315 configured to measure a local ambient temperature to provide a current local ambient temperature reading during an inventory measurement cycle. The microcontroller 320 of the SJB 325 may determine an AECCF as a function of the measured local ambient temperature by thermistor 315 relative to the weight measurement sensed by the inventory (weight) measurement sensors 340 on the legs or other parts of a vessel. The one or more processors or microcontroller 320, during an inventory measurement cycle, may be configured to determine an adjusted inventory (weight) measurement data (W_{AECCF}) of those individually addressable weight sensors in a non-failure state. The adjusted inventory (weight) measurement data (W_{AECCF}) may be a function of one of a highest weight of all addressable weight sensors in a non-failure state, a middle weight of all addressable weight sensors, a lowest weight of all addressable weight sensors in a non-failure state, a lowest weight of all addressable weight sensors, or an average of weights of all addressable weight sensors in a non-failure state. The weight measurement data (W_{AECCF}) (i.e., highest, middle, lowest or average) is adjusted with the AECCF.

The thermistor 315 may detect a local ambient temperature and generate an ambient temperature reading T_{amb} which is sent to the microcontroller 320 or processor.

Table 1 provides a table of variables, parameters and measurement terms, names, default values, units and description for calculating an ambient environmental condition compensation factor (AECCF).

TABLE 1

| | | | | |
|---|---|---|---|---|
| Variable | Name | Default | Units | Description |

MEASUREMENTS

| | | | | |
|---|---|---|---|---|
| TEMPERATURE | T_{amb} | | ° C. | Ambient temperature |
| RAW WEIGHT | W | | lbs. | Weight direct measurement |
| | | | | before conditioning |
| TIME | tᵢₙₜ | 15 | Minutes | Measurement interval |
| INTERVAL/ | | | | |
| TIMESTAMP | | | | |

PARAMETERS

| | | | | |
|---|---|---|---|---|
| ZERO COUNTS | ZC | 8388608 | Counts | The counts above the zero point |
| | | | | and represent a weight of the bin |
| | | | | being weighed |
| SCALE FACTOR | SF | 30 | Counts | Number of counts per unit of |
| | | | per lb. | weight to digital counts from |
| | | | | ADC |
| MINIMUM FILL | FILL | 1000 | lbs. | Minimum weight difference per |
| LOAD | | | | interval that qualifies as being in |
| | | | | filling mode |
| MAX_Δ-WHGT | MAX_ΔW | | lbs. per | Maximum weight acceptable as |
| PER INTERVAL | | | step | normal operation per interval. |
| MAX_Δ-TEMP | MAX_ΔT | | ° C. per | Maximum temperature rise per |
| PER INTERVAL | | | step | interval |

CALCULATIONS

| | | | |
|---|---|---|---|
| WEIGHT | Wₐᵥₑ | lbs. | A continuous average of the last |
| AVERAGE | | | n-values of weight |
| Δ-WEIGHT | ΔW | lbs. | Differential of weight from |
| | | | previous reading |
| Δ-TEMP | ΔT | ° C. | Differential of temperature from |
| | | | previous reading |
| TEMP. | dW/dt/dT/dt | lbs./° C. | Changes in weight per |
| CHANGES vs | | | temperature degree |
| WEIGHT | | | (dW/dt/dT/dt) |
| CHANGES | | | |
| COMPENSATED | W_{AECF(TC)} | lbs. | The averaged output weight |
| OUTPUT | | | corrected for dW/dT |

For illustrative purposes, an equation for determining an adjusted inventory (weight) measurement data (W_{AECCF}) is shown. The left side of the equation represents an average weight calculation of the measurement sensors 140 wherein there are N (n) measurement sensors 340. The anomaly detector module 330 may send the value n′ to the microcontroller 320 or the AWMC module 321 wherein n′ represents the number of remaining sensors in a non-failure state. The number n′ may be from 1 to N. Thus, when calculating an average weight, the equation is automatically updated with a count of those remaining measurement sensors 340. The average weight is calculated as the sum of the sensor measurements of remaining measurement sensors 340 divided by n′ (the count of the remaining sensors). In some embodiments, the adjusted inventory (weight) measurement (W_{AECCF}) may substitute the average weight for a single weight value as described above.

The weight measurements of the sensor include the weight of the structure of the vessel 5A (i.e., bin and legs) and the weight of the material 15 within the bin. Thus, the adjusted weight measurement (W_{AECCF}) is further adjusted by a zero count (ZC). The term “zero count” essentially zero's out the weight of the structure of the vessel 5A (FIG. 1A), such as the weight of the bin and/or the weight of the legs, depending on the placement of the measurement sensors 140 (FIG. 1A) or 340. The zero count is represented as a digital count as a function of the weight of the vessel and is subtracted from the average weight of the remaining measurement sensors.

The adjusted weight measurement (W_{AECCF}) may be further adjusted by a scaling factor (SF). The scaling factor is used to convert the digital counts of value represented as the average weight minus the zero count to represent a numerical value. This value is represented as essentially the material weight only and referred to as the adjusted weight measurement (W_{AECCF}). The scaling factor is a function of the counts generated by the analog-to-digital conversion.

The adjusted weight measurement W_{AECCF} may be further adjusted by an ambient environmental condition compensation factor (AECCF). The AECCF will be described in more detail in relation to FIG. 5A.

FIG. 3B illustrates a housing 333 of the SJB device 325 of FIG. 3A. The SJB device 325 includes a housing 333 with a panel 390. The panel 309 includes a plurality of measurement sensor connectors 362 configured to connect the sensors 340 to the internal components of the housing 333. Each connector 362 may be configured to coupled thereto a single inventory (weight) measurement sensor 340, for example. The connector 362 and the coupled inventory (weight) measurement sensor being individually addressable. The SJB device 325 may include a plurality of LED indicators 345. Each LED indicator 345 is in proximity of a corresponding connector 362 to represent a current status of the connected weight sensor.

The SJB device 325 further includes a power connector 380 such as for connecting 9-36 Volts in direct current (DC).

Each connector 362 is communicatively coupled to a corresponding (weight) measurement sensor 340 (FIG. 3A) of the N number of weight sensors to communicate an excitation signal to an individually addressable (weight) measurement sensor 340 (FIG. 3A). The connector 362 associated with a corresponding one (weight) measurement sensor, being configured to receive an inventory (weight) measurement signal in response to the excitation signal.

In some embodiments, one or more legs (FIG. 1A) may have more than one (weight) measurement t sensor coupled thereto, while other legs (FIG. 1A) have one (weight) measurement t sensor. By way of non-limiting example, a pair of (weight) measurement sensors may be coupled to a single sensor connector 362. In such an instance, the electrical signals of the pair of (weight) measurement sensors is averaged electrically. Nonetheless, more than one inventory (weight) measurement sensor may be coupled to a single sensor connector 362. However, those sensors would be addressed collectively such that their electrical signals are electrically averaged for a single input to the ADC form the associated connector 362.

In some embodiments, the plurality of weight sensors may be coupled to less than all the legs. For example, if a vessel has four legs, two or more of the (weight) measurement sensors may be coupled to one of the legs while another two or more of the (weight) measurement sensors may be coupled to another leg. Not all legs require an inventory (weight) measurement sensor.

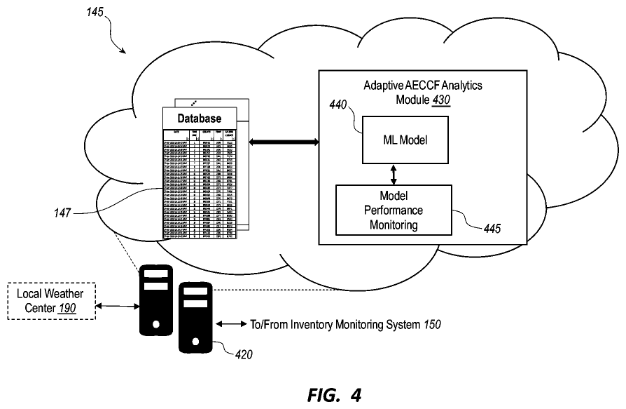

FIG. 4 illustrates a block diagram of the cloud 145 with the adaptive AECCF analytics module 430 associated with inventory monitoring and management. The cloud 145 may be implemented on one or more cloud servers 420 having cloud management software applications being executed on the processor(s) of the server 420. The cloud servers 420 may include components of a computing system as described in relation to FIG. 12. The cloud 145 may serve as a cloud engine for determining the AECCF described in herein using machine learning. The cloud servers 420 may optionally access a local weather center 190 to retrieve the ambient environmental conditions for which to derive the AECCF. For example, the cloud servers 420 may retrieve the wind speed for a particular location at a particular point in time correlated or nearly correlated to the time of the inventory measurement cycle. In those embodiments, where the adaptive AECCF analytics module 430 determines the AECCF instead of the SJB device 325, microcontroller 320 may eliminate the AECCF multiplier or set the multiplier AECCF equal to 1 from the inventory (weight) measurement sent to the cloud 145. The cloud 145 would apply the AECCF based on the predictive analytics or machine learning described herein, for example.

The adaptive AECCF analytics module 430 may include a machine learning (ML) model 440 to determine an adaptive AECCF. The adaptive AECCF analytics module 430 may include a model performance monitoring module 445 to monitor the model 440 and make any necessary adjustments. The model 440 receives the temperature measurement stored in a database 147 of the cloud 145 from the SJB device 325. The model 440 may also access the current inventory (weight) measurement of an SJB device 325. The cloud 145 may also store and track which inventory measurement sensors are in a failure state. The AECCF may be a function of a single inventory measurement sensor such as when the inventory measurement data is a function of a single reading (i.e., highest, middle, or lowest) selected from a plurality of inventory measurement sensors.

Real-time ambient temperature readings are a type of ambient environmental condition which may be correlated with the amount of stress exhibited by the inventory (weight) measurement sensor of the stress sensor gauge type or correlated with an electrical output representative of the collective weight from a measurement sensor, by way of non-limiting example. Thus, an ambient environmental condition compensation factor (AECCF) may be derived based on the real-time ambient temperature T_{amb}. Hence, in some embodiments, the inventor has determined that a Machine Learning algorithm represented by the ML model 440 may be used to correlate real-time ambient temperature readings to make necessary corrections to the weight measurement output from the SJB device 325.

By way of non-limiting example, the SJB device 325 may be configured to, during a time interval/time stamp tint for an inventory (weight) measurement cycle, which may be communicated to the cloud 145 via the gateway. The cloud 145 may query a local weather center 190, via the World Wide Web (WWW), to determine a current ambient wind speed WS_{amb} during the time interval. The ambient wind speed WS_{amb}, an ambient environmental condition, may be used in the Machine Learning algorithm to develop an ambient environmental condition compensation factor (AECCF) derived based on one or more of the real-time ambient temperature T_{amb} and the real-time ambient wind speed WS_{amb}. For example, at some points of time, the ambient temperature T_{amb} may not affect the measured amount of stress by a (weight) measurement sensor, but the current ambient wind speed WS_{amb} may. At other points of time, the ambient temperature T_{amb} and the current ambient wind speed may WS_{amb} both affect the measured amount of stress by a weight sensor is due to the force from the wind on the structure of the vessel. Still further, at other points of time, the ambient temperature T_{amb} may affect the measured amount of stress by a (weight) measurement sensor, but the current ambient wind speed WS_{amb} may not.

The algorithm of machine learning (ML) model may be a function of, by way of non-limiting example, neural networks, Bayesian networks, rule-based machine learning, and other artificial intelligence (AI) techniques. During the initial learning phase of the model, various vessels of varying material will be subjected to various temperature conditions and/or wind speed conditions with controlled material input to provide actual material inventory (weight) values verses measured inventory (weight) values. The initial learning phase may also vary the material to establish a model representative of the weight variations measured by the (weight) measurement sensors based on one or more ambient environmental conditions.

The adaptive AECCF analytics module 430 may query at least one database 147 located in the cloud 145 to receive the inputs previously stored by the SJB device 325 for an inventory measurement cycle. The cloud 145 may have a plurality of databases 147, each database may store a different model based on the location of the vessel, the weather seasons, the vessel type, and the material, for example.

The method blocks described below may be performed in the order shown or another order. In some embodiments, one or more of the block may be performed contemporaneously. Blocks may be added or deleted.

FIG. 5A illustrates a flowchart of a method 500 for calculating a weight of material within a bin being adjusted by an ambient environmental condition compensation factor (AECCF) based on the equation of FIG. 3A. The method 500 may be performed by the SJB device 324. The method 500 may comprise, at block 502, starting the inventory measurement cycle by the SJB device 325. The method 500 may comprise, at block 504, determining if a time interval has expired. If the interval has not expired, then at block 506, other inventory (weight) measurement functions and processes are carried out, such as anomaly detection, exciting the (weight) measurement sensors 340, etc. If the interval has expired, then at block 508, the sensors' weights or quantity of inventory from those measurement sensors, in the non-failure state, are read. The counts (i.e., ZC and SF) are read, as well as the ambient temperature by the microcontroller 320.

The method 500 may comprise, at block 510, updating the variables and averages 510, identified in Table 1. At block 512, the method 500 may calculate changes from the previous reading. The calculations are shown in Table 1, as well. The method 500 may comprise, at block 514, determining whether the change in weight (Δ-weight) is greater than the maximum change in weight (max_Δ-weight). The maximum change in weight may be set when initialing the parameters for a vessel. If the determination, at block 514, is “YES,” then the SJB device 325 determines that the vessel is set as filling in process (or filling), at block 516.

The method 500 may comprise, at block 518, calculating an average weight. At block 518, the adjusted inventory (weight) measurement may be calculated such as by the equation shown in FIG. 3A. The adjusted inventory (weight) measurement may be the adjusted weight measurement. At block 518, the adjusted weight measurement (W_{AECCF}) may be calculated wherein the AECCF is set to 1. In other words, when the bin of a vessel is being filled or replenished, the AECCF may be set to not affect the measured (weight) inventory being added. In the filling process, a quantity of inventory (material) is added to the bin. Thus, the tracked inventory may also include updates when the inventory (material) is being filled in the bin.

The method 500 may comprise, at block 520, sending out an adjusted weight measurement (W_{AECCF}) such as to the gateway 142 for transmission to the cloud 145. Block 520 may loop back to block 504 for the next timed interval of the measurement cycle.

Returning again to block 514, if the determination is “NO,” then at block 522 a determination is made whether the change in temperature (Δ-temp) since the previous interval is rising. If the determination is “NO,” block 522 returns to block 518 where the adjusted weight measurement W_{AECCF} may be calculated with the AECCF is set to 1. On the other hand, if the determination is “YES,” at block 522, the method 500 proceeds to block 524. At block 524, a determination is made whether a rate of the change in temperature (rate of Δ-temp) is greater than a maximum rate of change in temperature (max_rate of Δ-temp). If the temperature change is above the maximum rate of changed set up when initializing the vessel, then, at block 526, the adjusted weight measurement W_{AECCF} from the previous measurement cycle is not changed and remains the same. The adjusted weight measurement may remain the same when rapid changes in temperature are detected. Hence, the AECCF may be set to 1 or remains set to 1. Block 526, the adjusted weight measurement (W_{AECCF}) is sent to the cloud 145 and the remote inventory monitoring system 150. Once the temperature rate of change is stabilized, the adjusted weight measurement may be calculated using the AECCF.

Returning to block 524, if the rate of the change in temperature (rate of Δ-temp) is not greater than a maximum rate of change in temperature (max_rate of Δ-temp), then, at block 528, the AECCF is calculated based on statistics for which temperature affects materials. As shown, the AECCF is a function of the difference in the measured Δ-weight relative to the change in temperature (Δ-temp) and the expected change in Δ-weight of the stored material in the bin relative to the Δ-temp for the instant weight measurement sensor reading and calculations. The AECCF may be a function of the adjusted weight measurement for the local ambient temperature or change in temperature since the last cycle relative to the expected weight measurement for the same temperature or change in temperature since the last cycle.

FIG. 5B illustrates a table 560 for use in predictive analytics or machine learning to determine an ambient environmental condition compensation factor (AECCF). The table 560 may be updated for each weight measurement cycle and maintained in the cloud 145. The updated information may be used as inputs for creating, further training and refining the model 440 over time.

The table 560 includes a data and time column 562. The column 562 time stamps each log entry. The table 560 may include a local ambient temperature T_{amb}. The table 560 may also include an ambient wind speed WS_{amb} column 566. In some embodiments, the ambient wind speed may be sensed at the site of the vessel. The wind speed may cause the vessel body to affect the weight measurement. In some embodiments, the wind speed may move material within the bin more to one side of the bin making such one side slightly heavier.

The columns of the table 560 may include an age of the senor column 568, a leg material (LM) column 570 and product material (PM) 578. For example, the age of the sensor may cause a fluctuation in the sensor tolerance, for example. The leg material (LM) may be the same material of the vessel. The table 560 may include an expansion/contraction coefficient of the LM column 570 and expansion/contraction coefficient of the product material (PM) column 580. The table 560 may include a bin material expansion/contraction coefficient column (not shown). The columns 570 and 578 may be used to filter the data based on different material types for vessels and material, for example.

The table 560 may include a change in the local ambient temperature (Δ-temp) column 574 and an estimated stress change/delta column 576. The estimated stress may be based on the local ambient temperature, the wind speed and correlated with other parameters described in table 560. The table 560 may include an AECCF column 582. The AECCF value is derived such as during the initial training of the ML model 440.

FIG. 6A illustrates a graphical user interface (GUI) 600A for adding a location to be monitored and managed.

The GUI 600A may include navigation and control icons 601, 602 and 603. The navigation and control icon 601 represents a house, for example, and may be used to select inventory tracking details of one or more locations and vessels, as will be described in relation to FIG. 7A. The navigation and control icon 602 initializes and sets up locations with vessels whose inventory is to be tracked. The control icon 602 is represented as a location symbol. The GUI 600A is an example of a GUI displayed upon selection of the control icon 602 without any previous locations entered. The GUI 600A with navigation and control icon 602 allows for locations and their vessels for tracking their inventory to be setup. The navigation and control icon 603 when selected provides one or more GUIs for entering users or administrators, for example. The GUI 600A may include a search field 640, and a notification icon 636.

In GUI 600A selecting the add-a-location button 604 allows an add location window or box 620A to be displayed.

The add location box 620A in GUI 600A may include field 609 for entering a location name and fields 610 for entering an address of a location. The location may include field for street address, state or region, zip code and country. The GUI 600A may include add-a-bin icon 615 configured to allow a user to enter a bin number and a material. In this sense, bin refers to a vessel. The GUI 600A also includes a notification icon 636. A number is shown next to the icon 636 to represent the number of notifications or alerts available. The GUI 600A may include a cancel button 644 and a save button 646 to save the entered, deleted or edited content through this GUI 600A.

The add location box 620A may include a manage users button 612 and manage bins button 614. When the manage users button 612 is selected, a list of available users and/or administrators are listed in window 635A. The window 635A includes radial buttons 637 for selecting which user(s) can have access or administration rights to this location. Each radial button 637 has a name of a user 638. In some embodiments, a means of contacting the user 638 may be included.

FIGS. 6B-6D include similar features as the GUI 600A of FIG. 6A. Thus, like reference numerals represent like functions and icons. Further discuss of some duplicative elements will be omitted from the description below.

FIG. 6B illustrates a graphical user interface (GUI) 600B for editing a location by selecting users with permitted access. In GUI 600B, assume now that location 1 has been added. However, the location data needs to be edited. By selecting location icon 661 in box 660, the window or box 620B is displayed. In this illustration, the user intends to edit the users. To do so, the manage users button 612 is selected. Upon selection, the previously selected list of users is displayed in window 635B. The radial buttons 637 for a user previously checked may be unchecked. Likewise, a radial button 637 for an unselected user may be selected. The edits may be saved by save button 646. The edits may be canceled by cancel button 644.

FIG. 6C illustrates the GUI 600C with a plurality of individually selectable bins previously added, e.g., all bins associated with a particular location. Like reference numerals described above in relation to FIGS. 6A-6B will not be further described in FIG. 6C. By selecting the location icon 661 in the box 660 for Location 1 previously entered, causes GUI 600A, for example, to display a window or box 620C to edit the location data and setting. The previously added bins are displayed in response to selection of the manage bins button 614 from the edit location window or box 620C. The GUI 600C may display, in window 635 of window or box 620C and in proximity to the add-a-bin icon 615, one or more bins 650, 651, 652, 653 and 654 which have been previously added. For illustrative purposes, the GUI 600C displays five bins, each with a different bin being individually selectable. Upon selection of a bin, such as bin 651, such bin data may be edited via an edit bin window or box. Such edit bin window or box will be described in relation to the add a bin window or box in FIG. 6D.

The GUI 600C may include a search field 640 to search for existing locations by name or address. The data entered in the edit location window or box 620 may be canceled by cancel button 644 or saved by save button 646.

FIG. 6D illustrates the GUI 600D based on the GUI 600C of FIG. 6C for adding bins with a pop-up box 623 for entering the bin tracking information of a single bin. The selected bin is being added to Location 1. Selecting the add-a-bin icon 615 may cause a pop-up box 623 to be overlaid on window or box 620C. At this time, no information has been associated with the new bin icon. The pop-up box 623 includes a plurality of fields to be displayed or overlaid on pop-up box 623. The fields serve to enter a bin name 619, a bin capacity 620 in pounds, warning-level trigger point 621 in pounds, a serial number 622 of the bin, a critical-level trigger point 624 in pounds and material name 625. The pop-up box 623 may also include a discard button 626 and a create button 627, for example. The trigger points 621 and 624 serve to change the colors in the graphical representations of FIGS. 7A-7C and 10A-10B, for example.

FIG. 7A illustrates a graphical user interface (GUI) 700A having a plurality of bin icons representing percent of material currently within a plurality of bins with a notification window 760 overlaid on the GUI 700A. The GUI 700A is selectively display by selecting the control icon 701 (i.e., control icon 601).

The GUI 700A may display one or more entered bin icons 715 one or more bins being tracked, the location of the bin and the material stored in the bin. Some bins may have the same material of other bins. Other bins may have a different material. For illustrative purposes, the GUI 700A displays twelve bins. The bins icons 715 may represent a quantity level of material currently within the bin. The quantity level is updated in response to a measured change in weight during each weight measurement cycle.

The GUI 700A also includes a notification icon 736. The GUI 700A may include a filter field 724 and a search field 740. The GUI 700A further includes a sort button 725 to sort the bin icons such as based on quantity levels or other parameters including location, and material. The sorting may be low to high, high to low. In some embodiments, the sorting is in descending order or ascending order. In the illustration, the bins are ordered based on quantity of remaining material. Other metrics to sort the bins may be used. The GUI 700A may include a search field 740 to search for existing locations by name or address. The GUI 700A may include a cancel button 744 and a save button 746 to save the entered, deleted or edited content through this GUI 700.

The reference numeral 715 is directed to bins having a critical level of material denoted by the color. The bins 715 may display a percent or amount of material remaining in the bin. The critical level is set by the critical-level trigger point. The reference numeral 717 is directed to bins having a warning level of material set by the warning-level trigger point and may be denoted by a different color. The warning level may sometimes be referred to as a medium level. The bins 717 may display a percent or amount of material remaining in the bin. The critical level may sometimes be referred to as a low level. The reference numeral 719 is directed to bins having a level of material above the warning-level trigger point may have another color. The bins 719 may include an amount or percentage of material remaining in the bin above the warning-level trigger point.

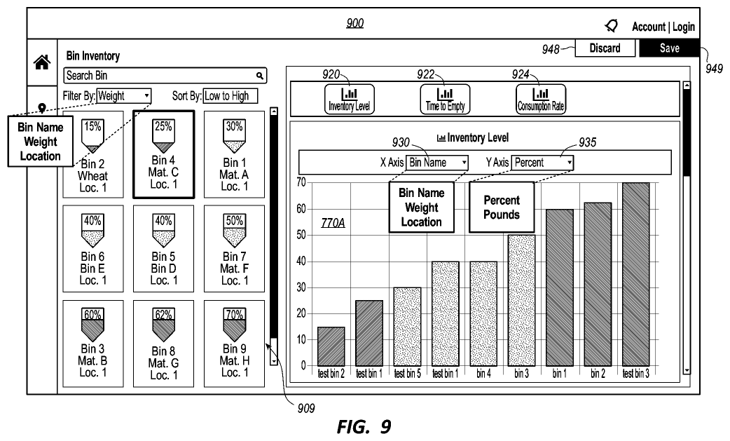

The GUI 700A may include an edit view button 750 wherein selection of the edit view button 750 may lead to selection menus for display of one or more of the fields represented in FIG. 9.

FIG. 7A illustrates a window 710A with a graphical representation 770A including a bar graph of the inventory levels of one or more bins and their corresponding material currently populated in window 709 of GUI 700A. Other graphing techniques may be used in lieu of a bar graph. The vertical axis represents increments of percent of remaining inventory of material. The horizontal axis includes a list of one or more bins, including material of the bin. In some embodiments, the list of one or more bins may identify the location of the bin. In some instances, inventory levels of more than one location may be included. In some embodiments, each bar may be color coded based on trip points for quantity of material (inventory) remaining in the bin. For example, bars at quantity levels at or below a first trip point representative of a low or critical quantity level may have a first color. Bars at quantity levels above the first trip point and at or below a second trip point higher than the first trip point may have a second color. By way of non-limiting example, the second color may be representative of a warning quantity level. Bars at quantity levels above the second trip point may be represented in a third color to represent a high quantity level.

The placement of the bars in graphical representation 770A may be ordered or sorted by color and/or weight. The bars may be ordered from least to most. Each bar may list the bin number/name, location and/or material along a horizontal axis. Furthermore, the vertical axis may be labeled in pounds (lbs.) or percent full.

In FIG. 7A, the displayed bins are associated with a user selected in FIG. 6B as having access. In FIG. 7A, while all the bins are for one location, the window 709 may display at least one bin from each location of a plurality of locations the user has been granted access. Furthermore, in a particular location, user access may be restricted by bin, as well.

FIG. 7B illustrates a window 710B with a graphical representation 770B including a bar graph of the predicted time to empty (depletion) of the one or more bins and their material currently populated in GUI 700A of FIG. 7A. The vertical axis represents increments of days. The horizontal axis includes a list of one or more bins, including material of the bin. In some embodiments, the list of one or more bins may identify the location of the bin. In some instances, predicted time to empty of one or more bins in one or more locations may be included. The window 710B may be viewed in GUI 700A by scrolling on the right-hand side of the GUI 700A. When graphical representation 770B is viewed, graphical representation 770A is scrolled out of view in GUI 700A.

Bars at quantity levels at or below a first trip point representative of certain number of low or critical number of days (first day's trip point) may have a first color. Bars at representative of a number of days above the first days' trip point and at or below a second days trip point higher than the first days' trip point may have a second color. By way of non-limiting example, the second color may be representative of a range of days. The range of days of the second color may be a warning range. Bars above the second trip point may be represented in a third color to represent a high number of days, for example. The bars may be grouped together based on days and/or color.

The placement of the bars in graphical representation 800B may be ordered or sorted by color and/or weight. The bars may be ordered from least to most. Each bar may be labeled with the bin number/name, location and/or material along a horizontal axis. Furthermore, the vertical axis may be labeled in hours or days or other increment of time.

FIG. 7C illustrates a window 710C includes a graphical representation 770C including a bar graph of the consumption rate of the material for the bins and their corresponding material currently populated in GUI 700A. The vertical axis represents increments of weight in pounds (lbs.). The horizontal axis includes a list of one or more bins, including material of the bin. In some embodiments, the list of one or more bins may identify the location of the bin. In some instances, inventory levels of more than one location may be included. In some embodiments, each bar may be color coded based on trip points selected for consumption rate for each bin. For example, bars at consumption rate levels at or below a first consumption trip point representative of a low or critical-level may have a first color. Bars at a consumption rate above the first consumption trip point and at or below a second consumption trip point may have a second color. By way of non-limiting example, the second color may be representative of a warning consumption rate. Bars at consumption rates above the second consumption trip point may be represented in a third color to represent a high consumption rate. The window 710C may be viewed in GUI 700A by scrolling on the right-hand side of the GUI 700A. When graphical representation 770C is viewed, graphical representation 770B is also scrolled out of view in GUI 700A.

In the illustration, the consumption rate is represented in terms of pounds per days (lbs./days). However, the consumption rate may be selected to be pounds per hour or other increments of time. The hours may be, for example, 1, 4, 8, 12, 16 or 20 hours. The consumption rate may be represented in pounds per days wherein days may be 1 or 7 days, for example. The placement of the bars in graphical representation 770C may be ordered or sorted by color and/or weight. The bars may be ordered from lowest to highest. Each bar may be labeled with the bin number/name, location and/or material along a horizontal axis.

FIG. 8A illustrates a graphical user interface (GUI) 800 with a notification window 860 overlaid on the GUI 800 and more specifically, graphical representation 770A. The GUI 800 is essentially the same as GUI 700A. Thus, only the differences will be described in detail. The notification icon 836 may include a number of current notifications. In the illustrations, the number is four notification message. The notification message setting may include an audible notification to indicate a notification message has been received. Selecting icon 836 causes the window 860 to be displayed. The window includes notification messages 862, 863, 864 and 865 in overlaid notification window 860. Types of messages may include notification messages 862 and 865 of a bin reaching a critical-level trigger point. The notification messages 862 and 865 may also identify the time and date of the trigger point was reached in a particular bin and location. The messages may include notification messages 863 and 864 representing delivery messages including data, time, location, bin, and amount of material.

While the notification window 860 is overlaid on graphical representation 770A, the window 860 may be overlaid on any graphical representation 770B and 770C. Each GUI described herein having a notification icon 736 or 836, for example, would overlay the notification window 860 over the current graphical representation.

FIG. 9 illustrates the GUI 900 to adjust the graphical representations of 770A-770C of FIGS. 7A-7C. The GUI 900 is similar to the GUI 700A of FIG. 7A. Thus, only those elements which are different will be described. FIG. 9 illustrates filter parameters include one of bin name, weight and location. The filter may alter the displayed bins in window 909. Buttons 920, 922 and 924 allow the user to select changes in graphical representations 770A-770C of inventory level, time to empty and consumption, respectively. Field 930 allows the X-axis of the inventory level representation to be altered. X-axis options may include bin name, location and weight. Field 935 allows the Y-axis to be altered. Y-axis options may include percent and pounds. The GUI 900 includes a discard button 948 and a save button 949.

FIG. 10A illustrates a graphical user interface (GUI) 1000A for inventory tracking and scheduling of a single selected bin denoted in selected box 1021 within window 1009 displaying an array of bins for at least one location. The GUI 1000A is display in response to selecting a navigations tool or icon 701. In this example, bin 4 for location 1 is selected. GUI 1000A includes similar features as described in relation to FIG. 7A. Thus, in some instances, duplicated icons and navigational tools or icons with not be further described. The GUI 100A includes graphical representations including a numerical amount of material remaining in a selected bin, a numerical value with the number of days (time) until the selected bin is empty and a numerical representation of daily consumption of the material in the selected bin, respectively.

The GUI 1000A may represent an amount of inventory of the selected one bin to assist an operator to make decisions about ordering a quantity of material. The user may select any bin for a location displayed in window 1009. The bin icons in the window 1009 also represent the level or weight of remaining material within the bin. The represented level or weight may be updated for each inventory measurement cycle.

The GUI 1000A includes a bin icon 1005 having a filled portion 1005 representing a quantity of material, such as in pounds, remaining in the bin selected in box 1021. The portion 1010 of the bin icon 1005 represents an unfilled portion. The GUI 1000A populates the data illustrated by accessing the updated inventory measurement in the cloud 145. Other options may represent the inventory quantity in terms of percent full. The filled portion 1006 may have different colors to represent a low or critical quantity, a warning quantity or a high quantity based on trip points described above.

The graphical representation 1015 may include a clock 1017 to represent an amount of time to empty. In the illustration, the clock 1017 may represent an increment of time in days. Other options may include hours in lieu of days, for example. The time to empty is based on various conditions including the rate of consumption. The clock 1017 is represented as a circle with a segment 1016 being colored to represent the amount of time left until the selected bin selected in box 1021 is empty. The color may change based on the amount of time left. The setting of the color is set at the time of setup of the bin. The right-hand side of FIG. 10A may represent a dashboard 1005. may include a consumption rate icon 1020.

The graphical representation 1020 in the GUI 1000A represents a consumption rate dial icon 1025 representing the determined daily consumption rate, for example. The dial icon 1025 provides a numerical reading 1026. In the illustration, the numerical reading 1026 is 150 lbs. daily. In other embodiments, the consumption rate dial icon 1025 may be selectively changed to represent the consumption rate in terms of a selected hourly rate such as 1, 4, 8, 12, 16 and 20 hours. In other embodiments, the consumption rate may be based on a single day or 7 days (i.e., a weekly consumption rate) by way of non-limiting example.

The graphical representation 1030 is for inventory scheduling management wherein the percent full in the bin icon 1032 and the percent full of the vehicle icon 1035 may generally equal 100% of the set capacity of the selected bin. The bin icon 1032 represented with the amount of material remaining. In this example, 25% of inventory is remaining for this material. The transportation vehicle icon 1035 with its material holding capacity shown. The material holding capacity may be divided into segments to represent a level of fill needed to replenish the material of the bin associated with the bin icon 1032. In the example, 75% fill would be needed in the transportation vehicle to fill the selected bin to a set maximum capacity. Each segment in vehicle icon 1035 may have a certain amount of capacity allotted to the segment.

In the window 1009, the bin icon in box 1099 represents an indicator bin with a least one failed sensor. This may allow the user to generate a repair notification for the bin's sensor.

FIG. 10B illustrates a further graphical representation 1040 depicting a graph of inventory history levels for a predetermined amount of time for a selected bin. The graphical representation 1040 may represent a graph of historical usage. The graphical representation 1040 may be accessed from GUI 1000A of FIG. 10A after a respective one bin is selected in the GUI 1000A. The window 1010B may be accessed by scrolling down below graphical representation 1030 of FIG. 10A. As the user scrolls, the graphical representations 1005, 1015 and 1020 scroll out of view of the GUI 1000A. Nonetheless, the arrangement of graphical representations 1005, 1015, 1020, 1030 and 1040 may have a different order than shown. The user may pan and zoom on the graphical representation 1040. The data of the graphical representation 1040 may be downloaded into a file. Indicator 188 allows the user to zoom in on a location in the graph for specific information.

The graphical representation 1040 includes a graph 1048 representing levels of material over 30 days, for example, in a plurality of increments, such as five (5) day increments. The predetermined amount of time may be 7 days, 30 days, 60 days or 90 days, for example. The line 1042, shows the quantities of material in percentages to represent the fluctuation in material levels over the selected time period. Other metrics of measurement of quantities of material may be used, such as by pounds.

The horizontal axis represents increments of time, such as days. The vertical axis may represent the percentage of material on hand. For example, if a bin is full to their limits, the graph may indicate those days at 100% inventory.

The graphical representation 1040 may include a line 1046 and 1047 representing the pre-set critical and warning values or trip points for the bin. The decreasing height of line 1042 represent the depletion of the material over time.

The graphical representations 1005, 1015, 1020, 1030 and 1040 may be individually displayed one below the other, such as, to display the GUI 1000A on a mobile platform of a mobile device (i.e., smartphone). Likewise, on a mobile platform or other computing platform, window 1009 may be displayed in GUI 1000A, wherein after selection of the bin in box 1021, the graphical representations 1005, 1015, 1020, 1030 and 1040 may be displayed one after the other or two graphical representations may be displayed side by side.

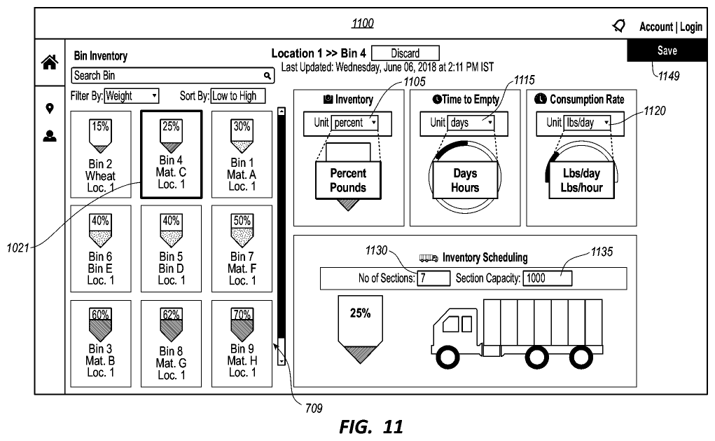

The GUI 1000A may include an edit view button 1050 which transitions the GUI 1000A to GUI 1100 described below in relation to FIG. 11.

FIG. 11 illustrates a graphical user interface (GUI) 1100 to modify the setting to display data represented by the inventory graphical representation, the time to empty graphical representation, consumption rate graphical representation and the inventory scheduling graphical representation. Upon selecting the edit view button 1050 of FIG. 10A, various fields 1105, 1115, 1120, 1130 and 1135 are displayed over graphical representations 1005, 1015, 1020, and 1030, respectively. Field 1130 and 1135 are associated with graphical representation 1030.

The field 1105 includes a drop-down window with various selections. In the illustration, the drop-down window for field 1105 may include percent and pounds. The field 1115 may also include a drop-down window with various selections. In the illustration, the drop-down window for field 1115 may include days and hours. The field 1120 may also include a drop-down window with various selections. In the illustration, the drop-down window for field 1120 may include pounds per day (lbs./day) or pounds per hour (lbs./hour).

The field 1130 for graphical representation 1030 may allow the number of sections for a vehicle. The number of sections entered in field 1130 would be displayed in the vehicle icon 1035. The field 1135 allows the user to enter the capacity for each section. This allows the user to manage delivery of material in an available vehicle 197.

The GUI 1100 may also include a save button 1149 to save the new settings for displaying the inventory graphical representation, the time to empty graphical representation, consumption rate graphical representation and the inventory scheduling graphical representation.

FIG. 12 illustrates a block diagram of a computer system 1200 for use in an embodiment of the inventory management system. Computer system 1200 includes a communication mechanism such as a bus 1210 for passing information between other internal and external components of the computer system 1200. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1200, or a portion thereof, constitutes a means for performing one or more steps of one or more methods described herein.

A sequence of binary digits constitutes digital data that is used to represent a number or code for a character. A bus 1210 includes many parallel conductors of information so that information is transferred quickly among devices coupled to the bus 1210. One or more processors 1202 for processing information are coupled with the bus 1210. A processor 1202 performs a set of operations on information. The set of operations include bringing information in from the bus 1210 and placing information on the bus 1210. The set of operations also typically include comparing two or more units of information, shifting positions of units of information, and combining two or more units of information, such as by addition or multiplication. A sequence of operations to be executed by the processors 1202 constitute computer instructions.

A processor 1202 may include a digital signal processor, a microcontroller, or other processor configurations.

Computer system 1200 also includes a memory 1204 coupled to bus 1210. The memory 1204, such as a random access memory (RAM) or other dynamic storage device, stores information including computer instructions. Dynamic memory allows information stored therein to be changed by the computer system 1200. RAM allows a unit of information stored at a location called a memory address to be stored and retrieved independently of information at neighboring addresses. The memory 1204 is also used by the processors 1202 to store temporary values during execution of computer instructions. The computer system 1200 also includes a read only memory (ROM) 1206, non-volatile persistent storage device or static storage device coupled to the bus 1210 for storing static information, including instructions, that is not changed by the computer system 1200. Also coupled to bus 1210 is a non-volatile (persistent) storage device 1208, such as a magnetic disk or optical disk, for storing information, including instructions, that persists even when the computer system 1200 is turned off or otherwise loses power.

Information, including instructions, is provided to the bus 1210 for use by the processor from an external input device 1212, such as a keyboard containing alphanumeric keys operated by a human user, or a sensor. A sensor detects conditions in its vicinity and transforms those detections into signals compatible with the signals used to represent information in computer system 1200. Other external devices coupled to bus 1210, used primarily for interacting with humans, include a display device 1214, such as a cathode ray tube (CRT) or a liquid crystal display (LCD), for presenting images, and a pointing device 1216, such as a mouse or a trackball or cursor direction keys, for controlling a position of a small cursor image presented on the display 1214 and issuing commands associated with graphical elements presented on the display 1214.

Computer system 1200 also includes one or more instances of a communications interface 1270 coupled to bus 1210. Communication interface 1270 provides a two-way communication coupling to a variety of external devices that operate with their own processors, such as printers, scanners and external disks. In general, the coupling is with a network link 1278 that is connected to a local network 1280 to which a variety of external devices with their own processors are connected. For example, communication interface 1270 may be a parallel port or a serial port or a universal serial bus (USB) port on a personal computer. In some embodiments, communications interface 1270 is an integrated services digital network (ISDN) card or a digital subscriber line (DSL) card or a telephone modem that provides an information communication connection to a corresponding type of telephone line. In some embodiments, a communication interface 1270 is a cable modem that converts signals on bus 1210 into signals for a communication connection over a coaxial cable or into optical signals for a communication connection over a fiber optic cable. As another example, communications interface 1270 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 1270 sends and receives electrical, acoustic or electromagnetic signals, including infrared and optical signals, that carry information streams, such as digital data.

The term computer-readable medium is used herein to refer to any medium that participates in providing information to the processors 1202, including instructions for execution. Such a medium may take many forms, including, but not limited to, non-volatile media, volatile media and transmission media. Non-volatile media include, for example, optical or magnetic disks, such as storage device 1208. Volatile media include, for example, dynamic memory 1204. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 1202, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 1202, except for carrier waves and other signals.

Logic encoded in one or more tangible media includes processor instructions on a computer-readable storage media.

Network link 1278 typically provides information communication through one or more networks to other devices that use or process the information. For example, network link 1278 may provide a connection through local network 1280 to a host computer 1282 or to equipment 1284 operated by an Internet Service Provider (ISP). ISP equipment 1284 in turn provides data communication services through the public, world-wide packet-switching communication network of networks now commonly referred to as the Internet 1290. A computer called a server 1292 connected to the Internet provides a service in response to information received over the Internet. For example, server 1292 provides information representing video data for presentation at display 1214.

The invention is related to the use of computer system 1200 for implementing the techniques described herein. According to one embodiment of the invention, those techniques are performed by computer system 1200 in response to processor 1202 executing one or more sequences of one or more instructions contained in memory 1204. Such instructions, also called software and program code, may be read into memory 1204 from another computer-readable medium such as storage device 1208. Execution of the sequences of instructions contained in memory 1204 causes processor 1202 to perform the method steps described herein. Thus, embodiments of the invention are not limited to any specific combination of hardware and software.

The signals transmitted over network link 1278 and other networks through communications interface 1270, carry information to and from computer system 1200. Computer system 1200 can send and receive information, including program code, through the networks 1280, 1290 among others, through network link 1278 and communications interface 1270. In an example using the Internet 1290, a server 1292 transmits program code for a particular application, requested by a message sent from computer 1200, through Internet 1290, ISP equipment 1284, local network 1280 and communications interface 1270. The received code may be executed by a processor 1202 as it is received or may be stored in storage device 1208 or other non-volatile storage for later execution, or both. In this manner, computer system 1200 may obtain application program code in the form of a signal on a carrier wave.

Various forms of computer readable media may be involved in carrying one or more sequence of instructions or data or both to a processor 1202 for execution. For example, instructions and data may initially be carried on a magnetic disk of a remote computer such as host 1282. The remote computer loads the instructions and data into its dynamic memory and sends the instructions and data over a telephone line using a modem. A modem local to the computer system 1200 receives the instructions and data on a telephone line and uses an infra-red transmitter to convert the instructions and data to a signal on an infra-red a carrier wave serving as the network link 1278. An infrared detector serving as communications interface 1270 receives the instructions and data carried in the infrared signal and places information representing the instructions and data onto bus 1210. Bus 1210 carries the information to memory 1204 from which a processor 1202 retrieves and executes the instructions using some of the data sent with the instructions. The instructions and data received in memory 1204 may optionally be stored on storage device 1208, either before or after execution by the processor 1202.

Computer-readable media means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, EEPROM, flash memory or other memory technology, CD-ROM, DVD or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, RF, infrared, acoustic or other types of signals.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another.

Unless otherwise defined, all terms (including technical and scientific terms) used herein have the same meaning as commonly understood by one of ordinary skill in the art to which embodiments of the invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While various disclosed embodiments have been described above, it should be understood that they have been presented by way of example only, and not limitation. Numerous changes, omissions and/or additions to the subject matter disclosed herein can be made in accordance with the embodiments disclosed herein without departing from the spirit or scope of the embodiments. Also, equivalents may be substituted for elements thereof without departing from the spirit and scope of the embodiments. In addition, while a particular feature may have been disclosed with respect to only one of several implementations, such feature may be combined with one or more other features of the other implementations as may be desired and advantageous for any given or particular application. Furthermore, many modifications may be made to adapt a particular situation or material to the teachings of the embodiments without departing from the scope thereof.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

Therefore, the breadth and scope of the subject matter provided herein should not be limited by any of the above explicitly described embodiments. Rather, the scope of the embodiments should be defined in accordance with the following claims and their equivalents.

1. A system comprising:
a plurality of weight measurement sensors coupled to one or more legs supporting a bin or parts of a vessel including the bin, each sensor sensing a parameter associated with a leg or a part of the vessel to which it is attached to sense a weight representative of a weight of the vessel including stored material within the bin; and
a smart junction box (SJB) device comprising:
a plurality of sensor connector ports, each connector port communicatively coupled to a corresponding one weight measurement sensor of the plurality weight sensors to communicate an excitation signal to an individually addressable weight measurement sensor and receive therethrough a weight measurement signal representative of the sensed weight in response to the excitation signal;
an adjusted weight measurement calculator (AWMC) module configured to calculate an adjusted weight measurement representative of a weight of remaining material in the bin based on the weight measurement signal from those weight measurement sensors in a non-failure state;
an anomaly detector module configured to detect an anomaly of each individually addressable weight measurement sensor in response to the received weight measurement signal of the addressed weight measurement sensor to determine whether any one addressed weight measurement sensor is in a failure state wherein the anomaly detector module removes each weight measurement sensor in the failure state from being used in calculations by the AWMC module; and
a communication port configured to communicate the adjusted weight measurement to a remote inventory monitoring system, for each weight measurement cycle.

2. The system of claim 1, wherein the adjusted weight measurement is determined as a function of one of a highest weight measurement signal of the weight measurements signals of the remaining non-failed sensors, a middle weight measurement signal of the weight measurement signals of the remaining non-failed sensors, a lowest weight measurement signal of the weight signals of the remaining non-failed sensors, and an average weight measurement signal of the weight measurement signals of the remaining non-failed sensors.

3. The system of claim 1, wherein the communicated adjusted weight measurement sent to the remote inventory monitoring system updates a value representative of the quantity of the material corresponding to the adjusted weight measurement associated with said each weight measurement cycle for display in a display screen via an inventory tracking graphical user interface.

4. The system of claim 1, wherein the detected anomaly being one of an open circuit condition, a short circuit condition, measured signal out-of-expected range, rapid measured signal fluctuations and a non-responsive condition.

5. The system of claim 1, wherein the SJB device further comprising a thermometer for measuring a local ambient temperature; and the adjusted weight measurement being determined based on predictive analytics as a function of the local ambient temperature, and at least one of an expansion/contraction coefficient of a material of the leg or a material of the vessel, and a determined difference in the adjusted weight measurement versus an expected adjusted weight measurement for the local ambient temperature between adjacent weight measurement cycles, wherein the predictive analytics employ a machine learning approach to derive an ambient environmental condition compensation factor as a function of at least one of the local ambient temperature and an ambient wind speed to adjust the adjusted weight measurement.

6. (canceled)

7. An inventory management system, comprising:
a plurality of weight measurement systems, each weight measurement system comprising a set of individually addressable weight measurement sensors configured to be attached to a vessel with a bin and sense a weight of the vessel having a quantity of material within the bin, and a smart junction box (SJB) device configured to excite the set of weight measurement sensors, receive the sensed weight from the set of weight measurement sensors and derive an adjusted weight measurement representative of the quantity of material within the bin, based an average weight calculation using only remaining non-failed weight measurement sensors; and
a remote inventory monitoring system comprising one or more processors configured to track and update individually and collectively, the quantity of material within a plurality bins of a plurality of vessels, based on each adjusted weight measurement received from the plurality of weight measurement system for each respective measurement cycle associated with each respective weight measurement system.

8. The system of claim 7,
wherein the SJB device further comprising an anomaly detector module configured to detect an anomaly of each individually addressable weight measurement sensor in response to each sensor's weight measurement signal to determine whether any one weight measurement sensor is in a failure state, the detected anomaly being one of an open circuit condition, a short circuit condition, measured signal out-of-expected range, rapid measured signal fluctuations and a non-responsive condition,
and wherein the SJB device further comprising a thermometer device configured to measure a local ambient temperature during each weight measurement cycle wherein the SJB including one or more processors configured to:
determine an ambient environmental condition compensation factor (AECCF) as a function of the measured local ambient temperature relative to a change in the adjusted weight measurements between the measurement cycles and an expected adjusted weight measurement; and
adjust the measured weight measurement with the AECCF being a function of the local ambient temperature, wherein the adjusted weight measurement being determined based on predictive analytics as a function of the local ambient temperature, and at least one of an expansion/contraction coefficient of a material of the vessel, and a determined difference in the adjusted weight measurement verses an expected adjusted weight measurement for the local ambient temperature between weight measurement cycles.

9-11. (canceled)

12. The system of claim 11, wherein the predictive analytics employ a machine learning approach to derive an ambient environmental condition compensation factor as a function of at least one of the local ambient temperature and an ambient wind speed to adjust the adjusted weight measurement.

13. A system comprising:
a plurality of weight measurement sensors coupled to one or more legs supporting a bin or parts of a vessel including the bin, each sensor sensing a weight associated with a leg or part of the vessel to which it is attached, the sensed weight representative of a weight of the vessel including stored material within the bin; and
a smart junction box (SJB) device comprising:
a thermometer device configured to measure a local ambient temperature during a weight measurement cycle;
a machine learning model configured to determine an ambient environmental condition compensation factor (AECCF) as a function of the measured local ambient temperature to compensate for thermal effects on one or more of the material stored in the bin and a material of the vessel or the legs;
an adjusted weight measurement calculator (AWMC) module configured to calculate an adjusted weight measurement representative of a weight of the stored material in bin based on the sensed weight from those weight measurement sensors in a non-failure state and the AECCF, during the weight measurement cycle; and
a communication port configured to communicate the adjusted weight measurement to an inventory monitoring system for each weight measurement cycle.

14. The system of claim 13, wherein the communicated adjusted weight measurement sent to the remote inventory monitoring system updates a value representative of a quantity of the material corresponding to the adjusted weight measurement associated with said each weight measurement cycle for display in a display screen associated with an inventory tracking graphical user interface.

15. A system comprising:
a weight measurement system having a plurality of weight measurement sensors, the weight measuring system determining an adjusted weight measurement representative of a weight of a quantity of remaining material stored in a bin, the adjusted weight measurement being compensated for at least one ambient environmental condition local to the bin;
a display device having a display screen;
one or more processors coupled to the display device and being configured to:
receive, at each weight measurement cycle, the adjusted weight measurement from the weight measurement system;
update the weight of the quantity of the stored material in memory coupled to the one or more processors; and
selectively display in a graphical user interface the updated weight of the quantity of the stored material to track an amount of inventory of the stored material based on a critical-level trigger point and/or a warning-level trigger point to visually represent a need to schedule a delivery of a quantity of order material to replenish the stored material.

16. The system of claim 15, wherein the one or more processors configured to selectively display a graphical user interface with data fields for entering the critical-level trigger point in pounds, the warning-level trigger point in pounds and a storage capacity of the bin.

17. The system of claim 15, wherein the one or more processors configured to selectively display a representation of one or more of a consumption rate of the stored material in the bin and a time interval to empty the stored material based on the updated weight of the quantity of the stored material in the bin.

18. A system comprising:
a plurality of weight measurement systems, each weight measurement system having a plurality of weight measurement sensors, and module to calculate an adjusted weight measurement representative of a weight of a quantity of remaining material stored in a bin;
a display device having a display screen;
one or more processors coupled to the display device and being configured to:
receive, from each different weight measurement systems, their adjusted weight measurement representative of the weight of the quantity of the remaining material in each different bin associated with a different weight measurement system of the plurality of weight measurement systems;
update the weight of the quantity of the remaining material in memory, coupled to the one or more processors, for each different bin; and
selectively display in a graphical user interface the updated weight of the quantity of the stored material for each different bin to track an amount of inventory of the stored material in each different bin based on a critical-level trigger point and a warning-level trigger point to visually represent a need to schedule a delivery of a quantity of order material to replenish the stored material in any one different bin.

19. The system of claim 18, wherein the one or more processors configured to selectively display a representation of one or more of a consumption rate of the stored material in the each different bin of the different weight measurement systems simultaneously in an ordered graphical representation and a time interval to empty the stored material based on the updated weight of the quantity of the stored material in the each different bin of the different weight measurement system simultaneously in an ordered graphical representation.

20. A graphical user interface (GUI) configured to be displayed on a display screen in an inventory management system comprising a plurality of inventory measurement systems, each inventory measurement system having at least one inventory measurement sensor to measure a quantity of inventory representative of material in a bin of a vessel, the GUI when executed on one or more processors coupled to the display device being configured to:
access a cloud server;
receive from the cloud server the measured quantity of inventory representative of the material;
track set trigger points indicative of a critical level and a warning level to change a representation of a displayed measured quantity of the material;
selectively display in on the display screen an updated quantity of inventory for a bin icon or graphical representation representative of the received measured quantity of inventory from the cloud server by changing a color or pattern of at least a portion of the bin icon or graphical representation too represent the updated quantity of inventory wherein the color or pattern is a function of the set trigger points and the measured quantity of the inventory representative of the material is compensated by the inventory measurement system for an ambient environmental condition.

21. The GUI of claim 20, wherein the inventory measurement sensor measures the depth level of the inventory within the bin.

22. The GUI of claim 21, wherein the inventory measurement sensor comprises one or more of the following devices:
(a) LIDAR;
(b) camera;
(c) radar;
(d) laser range finder; and
(e) ultrasound.

23. A graphical user interface (GUI) configured to be displayed on a display screen in an inventory management system comprising a plurality of inventory measurement systems, each inventory measurement system having at least one inventory measurement sensor to measure a quantity of inventory representative of material in a bin of a vessel, the GUI when executed on one or more processors coupled to the display device being configured to:
access a cloud server;
receive from the cloud server the measured quantity of inventory representative of the material being compensated for ambient environmental conditions using machine learning;
track set trigger points indicative of a critical level and a warning level to change a representation of a displayed measured quantity of the material;
selectively display in on the display screen an updated quantity of inventory for a bin icon or graphical representation representative of the received measured quantity of inventory from the cloud server by changing a color or pattern of at least a portion of the bin icon or graphical representation too represent the updated quantity of inventory wherein the color or pattern is a function of the set trigger points.

24. The GUI of claim 23, wherein the inventory measurement sensor measures the depth level of the inventory within the bin.

25. The GUI of claim 24, wherein the inventory measurement sensor comprises one or more of the following devices:
(f) LIDAR;
(g) camera;
(h) radar;
(i) laser range finder; and
(j) ultrasound.
